(19) United States
(12) Patent Application Publication
(10) Pub. No.: US 2005/0173907 A1
(43) Pub. Date: Aug. 11, 2005

(54) Inflatable curtain deployment guide

(76) Inventor: Richard Welford, Layton, UT (US)

Correspondence Address: Sally J. Brown;AUTOLIV ASP, INC., 3350 Airport Road, Ogden, UT, 84405, US

(21) Appl. No.: 10/772,697

(22) Filed: Feb. 5, 2004

(51) Int. Cl. B60R 21/16

(52) U.S. Cl. 280/743.1

(57) ABSTRACT

A deployment guide assembly to guide the deployment trajectory of an airbag is disclosed. The deployment guide assembly guides the deployment of an inflatable curtain adjacent a side structure of a vehicle. The deployment guide assembly includes a guide member slidably engaged within guide rails. The guide member is capable of being in a retracted position and a guiding position. The deployment guide assembly is mounted inside a headliner adjacent the inflatable curtain in the retracted position. When the inflatable curtain deploys, it contacts the guide member and through friction, moves the guide member to the guiding position. The guide member in the guiding position directs the deployment of the inflatable curtain parallel to a side structure of a vehicle.

### BACKGROUND OF THE INVENTION

1. Field of the Invention

The present invention relates to airbag deployment guides. More specifically, the present invention relates to airbag deployment guides to be used in conjunction with inflatable curtains or overhead airbags to provide for a repeatable deployment angle of such airbags.

2. Description of Related Art

Safety belts are designed to protect the occupants of a vehicle during events such as automobile collisions. In low-speed collisions, the occupants are generally protected from impact with objects located inside the vehicle such as the windshield, the instrument panel, a door, the side windows, or the steering wheel by the action of the safety belt. In more severe collisions, however, even belted occupants may experience an impact with the car's interior. Airbag systems were developed to supplement conventional safety belts by deploying into the space between an occupant and an interior object or surface in the vehicle during a collision event. The airbag acts to decelerate the occupant, thus reducing the chances of injury to the occupant caused by contact with the vehicle's interior.

Many typical airbag systems consist of several individual components joined to form an operational module. Such components generally include an airbag cushion, an airbag inflator, a sensor, and an electronic control unit. Airbag cushions are typically made of a thin, durable fabric that is folded to fit into a compartment of a steering wheel, dashboard, interior compartment, roof, roof rail, roof compartment, or other space in a vehicle. The airbag inflator is designed to produce a gas to rapidly inflate the cushion when needed. The sensors detect sudden decelerations of the vehicle that are characteristic of an impact. The readings taken by the sensors are processed in the electronic control unit using an algorithm to determine whether a collision has occurred.

Upon detection of an impact of sufficient severity, the control unit sends an electrical signal to the inflator. The inflator uses one of many technologies, including pyrotechnic compounds and pressurized gas, to produce a volume of an inflation gas. The inflation gas is channeled into the airbag, rapidly inflating it. Inflation of the airbag causes it to deploy, placing it in position to receive the impact of a vehicle occupant. After contact of the occupant with the airbag and the corresponding deceleration of the occupant, the airbag rapidly deflates. To accomplish this, the inflation gas is vented from openings in the airbag, deflating it and freeing the occupant to exit the vehicle.

As experience in the manufacture and use of airbags has increased, the engineering challenges involved in their design, construction, and use have become better understood. Most airbag systems are designed to rapidly inflate and provide a cushion in proximity to a vehicle occupant. Many such cushions are configured to be placed in front of a vehicle occupant. Placement of the cushions is determined based on presumptions made of the position of a vehicle occupant during normal operation of the vehicle. Thus, a vehicle occupant enjoys optimal protection from a specific airbag when the occupant is in the presumed range of positions when the airbag deploys.

In some situations, injuries have occurred when the occupant is “out of position” with regard to the presumed position discussed above. Injuries similar to out of position injuries may also result from improper deployment of the airbag. Improper deployment may result in either poor placement of the cushion when contacted by a vehicle occupant or incursion of the airbag cushion into the space reserved for the vehicle occupant. Such incursion during deployment may raise the probability of injury to the vehicle occupant.

Different types of airbag systems have been developed to supplement or act as an alternative to frontally-placed airbag cushions. For example, inflatable curtain airbag systems were developed to cushion an occupant from a side structure of the vehicle. Such laterally-deploying cushions are engineered to deploy into position alongside an occupant without exerting a force directly toward the vehicle occupant.

Additionally, overhead airbag systems were developed as an alternative to frontally-placed airbag cushions. Such overhead cushions are advantageous in some situations since they deploy into position without exerting a force directly toward the vehicle occupant. In addition, positioning of the primary airbag in the roof of the vehicle when stored allows for greater design flexibility of the steering wheel and/or dashboard components of the vehicle.

However, one difficulty faced in the design and installation of inflatable curtains and overhead airbags is that the trajectory of deploying overhead airbags must be carefully controlled. Because inflatable curtains and overhead airbags are generally placed above vehicle occupants, their rapid deployment downward into a vehicle cabin may place an occupant at risk of injury. If inflatable curtains and overhead airbags inflate rapidly at an undesirable angle, they may impinge into space reserved for the head and/or upper body of a vehicle occupant, thus creating a potential for injury to the occupant or less efficient operation of the airbag.

This potential for injury may be heightened when the vehicle occupant is out of the position anticipated for them in the vehicle by the vehicles' engineers. For example, an occupant could be leaning against the side structure of the vehicle instead of sitting upright in their seat. If the angle of deployment is not parallel with the side structure of the vehicle, there is a possibility of an increased risk of injury with an out of position occupant.

Additionally, overhead airbags have an additional problem in that they may encounter sun visors or other roof-mounted accessories during deployment. Such obstacles may deflect or trap an inflating airbag cushion, thus compromising the protection provided to the vehicle occupant.

One of the methods employed to provide for repeatable deployment of inflatable curtains or overhead airbags at a proper angle is the use of complex folding methods. Such folding methods of inflatable curtains and overhead airbags include a combination of folding, rolling, and/or pleating in such a manner that the airbag deploys at the same angle parallel to a window on most occasions. However, such complicated folding techniques require the use of complex folding machines when manufacturing the airbags, thereby increasing the costs of manufacture. Additionally, these folding methods increase the size of the folded airbag making it more difficult to fit in an envelope between the roof and the headliner of a vehicle. Although these folding methods generally provide for repeatable deployment angles, variation in the angle still exists on occasion.

Accordingly, a need exists for a method and apparatus for regulating the deployment trajectory of inflatable curtains or overhead airbags. More specifically, a need exists for an apparatus that can be used to guide the deployment of inflatable curtains and overhead airbags parallel to a side window, windshield, or rear window without the use of complex folding methods. Such an apparatus is disclosed herein.

### BRIEF SUMMARY OF THE INVENTION

The apparatus of the present invention has been developed in response to the present state of the art, and in particular, in response to the problems and needs in the art in providing for a repeatable deployment trajectory of an airbag. Thus, the present invention provides an apparatus capable of guiding the deployment of an inflatable curtain parallel to a side structure of the vehicle. The apparatus of the present invention may also be used in conjunction with other airbag systems, such as overhead airbag modules, to guide the deployment of those airbags in a desired trajectory.

In accordance with the invention as embodied and broadly described herein in the preferred embodiment, a deployment guide assembly is provided. According to one embodiment, the deployment guide assembly may comprise a guide member that is slidably engaged within guide rails. The guide member is a generally planar structure that is positioned adjacent a stowed inflatable curtain or other airbag. When the inflatable curtain deploys, it contacts the guide member. The inflatable curtain then moves the guide member from a retracted position to a guiding position via frictional forces. The side of the guide member adjacent the inflatable curtain may have a roughed surface to facilitate the frictional pull of the guide member by the deploying inflatable curtain.

The guide member may have rail engagement arms that extend from the guide member and engage slotted sections in the guide rails. The rail engagement arms keep the guide member engaged with the guide rails and also act as a structural stop to hold the guide member in the guiding position when extended by the deploying inflatable curtain. In one embodiment, adjacent each slotted section of the guide rail is a catch that releasably retains the guide member in the retracted position. When the inflatable curtain deploys, the frictional force against the guide member releases it from the catch. The guide member can then move from the retracted position to the guiding position.

The deployment guide assembly of the present invention is mounted inside a headliner on an inboard side of the stowed inflatable curtain. The deployment guide assembly may also be mounted adjacent a B-pillar of the vehicle to prevent the inflatable curtain from deploying toward an occupant after rebounding off the B-pillar during deployment.

When the inflatable curtain deploys, it contacts the guide member and moves it from the retracted position to the guiding position. The guide member in the guiding position extends several inches below the headliner into a vehicle compartment. The deployment guide assembly is thereby self-positioning in that it does not require additional structure or mechanisms to extend the guide member other than the deploying inflatable curtain.

Once the guide member is moved to the guiding position, it directs the deploying inflatable curtain substantially parallel to a side structure of the vehicle. By deploying parallel to the side structure of the vehicle, the inflatable curtain is more likely to properly and safely deploy. The effectiveness of the inflatable curtain in providing impact protection and occupant retention is maximized. Potential injury to an out of position occupant is mitigated when the inflatable curtain repeatably deploys parallel to the side structure of the vehicle.

These and other features and advantages of the present invention will become more fully apparent from the following description and appended claims, or may be learned by the practice of the invention as set forth hereinafter.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a partially cut-away perspective view of a deployment guide assembly of the present invention mounted inside a vehicle adjacent a deploying inflatable curtain, the deployment guide assembly having a guide member extended in a guiding position;

FIG. 2 is a perspective view of the deployment guide assembly of the present invention;

FIG. 3 is a partially cut-away, side cross-sectional view of the deployment guide assembly mounted inside a headliner of a vehicle adjacent an inflatable curtain before deployment as viewed from the front of the vehicle, looking rearward;

FIG. 4 is a partially cut-away, side cross-sectional view of the deployment guide assembly in contact with a deploying inflatable curtain, the guide member being moved from a retracted position to a guiding position as viewed from the front of the vehicle looking rearward; and

FIG. 5 is a partially cut-away, side cross-sectional view of the guide member being in the guiding position adjacent a fully deployed inflatable curtain as viewed from the front of the vehicle looking rearward.

### DETAILED DESCRIPTION OF THE INVENTION

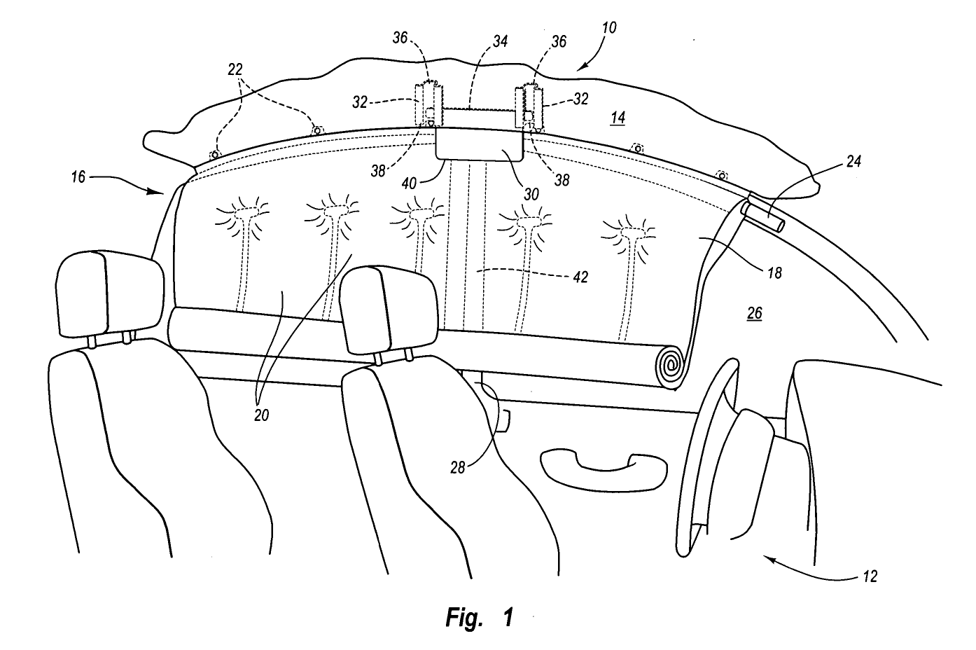

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1 through 5, is not intended to limit the scope of the invention, as claimed, but is merely representative of presently preferred embodiments of the invention.

Referring to FIG. 1, a deployment guide assembly 10 of the present invention is depicted from a partially cut-away perspective view mounted in a motor vehicle 12. The deployment guide assembly 10 is shown in phantom mounted inside a headliner 14 adjacent a deploying inflatable curtain 16. The inflatable curtain 16 is a safety restraint device comprising an inflatable cushion 18 having a plurality of chambers 20 designed to extend downwards from a roof rail (not shown) when inflated and cushion an occupant. The inflatable curtain 16 may also have a plurality of mounting tabs or clips 22 for mounting the inflatable curtain 16 adjacent a roof rail of the vehicle 12.

An inflator 24 is used to generate inflation gas to rapidly inflate the cushion 18. The inflator 24 is a pyrotechnic that uses the combustion of gas-generating material to generate inflation gas. Alternatively, the inflator 24 may contain a stored quantity of pressurized inflation gas or a combination of pressurized inflation gas and ignitable material for heating the inflation gas.

The deployment guide assembly 10 is mounted adjacent the inflatable curtain 16 when the inflatable curtain 16 is in its stored state. The deployment guide assembly 10 is mounted to the headliner 14 adjacent the inflatable curtain 16 through the use of adhesives, tacking, or other methods of attachment known in the art. In an alternative embodiment, the deployment guide assembly 10 is suspended from the roof rail or otherwise positioned adjacent the inflatable curtain 16.

The deployment guide assembly 10 is typically mounted on an inboard side of the inflatable curtain 16 so as to guide the deployment of the inflatable curtain 16 substantially parallel to the side windows 26 or side structure 28 of the vehicle 12. It is desirable for the inflatable curtain 16 to deploy parallel to the side structure 28 of the vehicle 12 in order to minimize potential injury to an out of position occupant. By deploying parallel to the side structure 28 of the vehicle 12, the inflatable curtain 16 is less likely to deploy towards an occupant. Therefore, the risk of injury to an occupant is reduced, particularly for an out of position occupant.

The deployment guide assembly 10 includes a guide member 30 that is slidably retained by two guide rails 32. More or less than two guide rails may be used, as long as the guide member 30 may be guided from a retracted position to a guiding position. A top edge 34 of the guide member 30 is adjacent a top edge 36 of the guide rails 32 when in the retracted position (not shown). The guide member 30 is depicted in a guiding position where the top edge 34 of the guide member 30 is adjacent the bottom edge 38 of the guide rails 32. When in the guiding position, a bottom edge 40 of the guide member 30 may extend several inches below the headliner 14.

When activated, the inflator 24 inflates the inflatable curtain 16 which, in turn, begins to unroll and/or unfold from a stored position adjacent the roof rail. While deploying, the inflatable curtain 16 contacts the guide member 30, and through frictional forces causes the guide member 30 to move from the retracted position to the guiding position. Hence the deployment guide assembly 10 is self-positioning in that it does not require additional structure or mechanisms to extend the guide member 30 except for the deploying inflatable curtain 16.

The deployment guide assembly 10 is also mounted adjacent the B-pillar 42 of the vehicle 12. In conventional inflatable curtain systems, the B-pillar 42 of the vehicle often causes problems in interfering with the deployment trajectory of the inflatable curtain 16. By positioning the deployment guide assembly 10 adjacent the B-pillar 42, the tendency of the inflatable curtain 16 to rebound off of the B-pillar 42 upon deployment is mitigated and the deployment trajectory is desirably aimed downward, parallel to the side structure 28 of the vehicle 12.

The various components described and illustrated in conjunction with FIG. 1 may be altered, rearranged, omitted, or supplemented with additional parts in a variety of ways. For instance, more than one guide member 30 may be positioned adjacent the inflatable curtain 16. Additionally, the deployment guide assembly 10 could be used in conjunction with other airbag systems, such as overhead airbag systems that deploy parallel to the windshield or rear window of a vehicle.

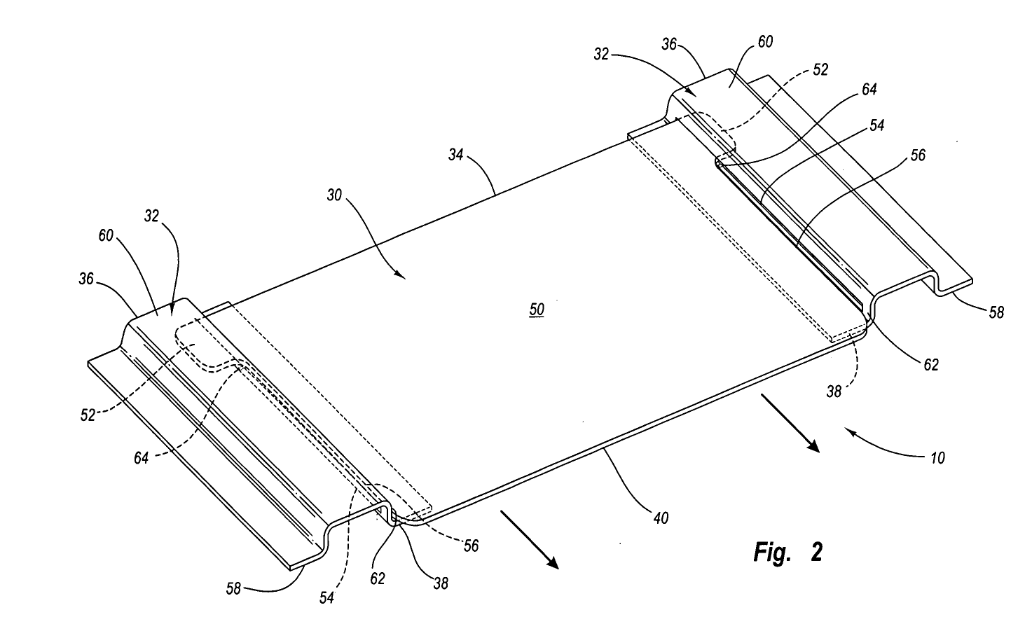

Referring to FIG. 2, the deployment guide assembly 10 of the present invention is depicted from a perspective view isolated from a motor vehicle. The deployment guide assembly 10 includes a guide member 30 that is slidably engaged with two guide rails 32. The guide member 30 is depicted in a retracted position where the top edge 34 of the guide member 30 is adjacent the top edge 36 of the guide rails 32. The guide member 30 can be slidably moved from the retracted position toward a guiding position where the top edge 34 of the guide member 30 is adjacent the bottom edge 38 of the guide rails 32.

The guide member 30 is a generally planar structure that may be approximately 1 mm to 1.5 mm thick. However, the guide member 30 could be thicker or thinner depending upon the need for resiliency or flexibility and the size of the envelope it can be installed in adjacent an inflatable curtain. The guide member 30 is sufficiently stiff so as not to give way against the force of an impinging inflatable curtain upon deployment.

The guide member 30 can be constructed of plastic, metal, or similar material known in the art. Plastics such as ABS plastic, polycarbonate, polypropylene, or other forms of engineering plastics may be used. An engineering plastic is a term generally used to describe a high-grade plastic that is stable over a wide environmental range, such as temperature or tendency to degrade under UV light, etc. Often engineering plastics are a hybrid or blend of various plastic materials.

In one alternative, the guide member 30 also has a roughed surface on a side 50 adjacent the inflatable curtain 16. The surface of the guide member 30 may have a heavy grain or it can be ribbed. A roughed surface will help facilitate the ability of the inflatable curtain 16 to move the guide member 30 from the retracted position to the guiding position by increasing the friction between the deploying fabric airbag and the guide member 30.

The guide member 30 may further have rail engagement arms 52 that engage slotted sections 54 of the guide rails 32. The rail engagement arms 52 may be a protrusion such as a pin, tab, or similar projection that extends from each lateral side 56 of the guide member 30. The rail engagement arms 52 keep the guide member 30 engaged with the guide rails 32 and also act as a structural stop to hold the guide member 30 in the guiding position when extended by the deploying inflatable curtain so the guide member 30 does not fall into the passenger compartment of the vehicle when extended.

The guide member 30 is shown having a generally rectangular shape, however other alternative shapes may be envisioned by one having skill in the art with the aid of the present disclosure. For instance, the bottom edge 40 of the guide member 30 may have a concave profile, which may affect the trajectory of the deploying inflatable curtain. Alternative shapes of the guide member 30 could be used to modify the deployment direction of the inflatable curtain as needed in different vehicular environments.

The guide rails 32 may also take various shapes as necessitated by the environment in which the guide rails 32 are to be mounted. The guide rails 32 of the present embodiment have a flat mounting surface 58 to which an adhesive may be applied to bond the guide rails 32 to the inside of the headliner. The guide rails 32 further have a raised surface 60 shaped to be substantially parallel to the headliner. The profile of the guide rails 32, as viewed from the bottom edge 38 looking toward the top edge 36, shows the mounting surface 58 running parallel to the headliner. The guide rails 32 then extend away from the headliner toward the raised surface 60 and then back down again to form another mounting surface 58.

The shape of the guide rails 32 provides for a smooth surface against which the inflatable curtain may deploy and not become damaged if it rubs against the guide rails 32 upon deployment. Alternatively, the guide rails 32 may be shaped in a different manner, such as an L-shaped bracket. However, it is desirable to ensure that no sharp edges would be exposed to the inflatable curtain so as not to damage it upon deployment.

The guide rails 32 further have slotted sections 54 that extend from adjacent the top edge 36 to proximate the bottom edge 38, without actually extending all the way through the top or bottom edges 36, 38 of the guide rails 32. The slotted sections 54 are located on an inner surface 62 of the guide rails 32. The slotted sections 54 slidably receive the rail engagement arms 52 of the guide member 30. Adjacent each slotted section 54 is a catch 64 that releasably retains the guide member 30 in the retracted position. The catch 64 can be a frangible pin, detent mechanism, or similar interference component that blocks the path of the rail engagement arms 52 in the slotted sections 54 to prevent the guide member 30 from extending to the guiding position via gravitational forces. The catch 64 releases the rail engagement arms 52 when the force of the deploying inflatable curtain contacts the guide member 30. The guide member 30 can then extend from the retracted position to the guiding position.

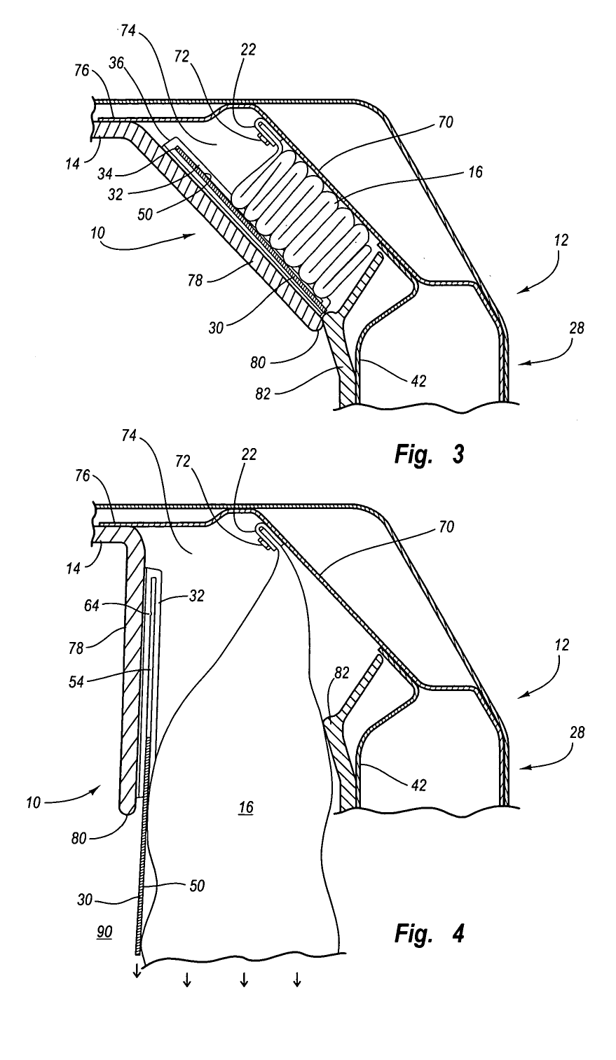

Referring to FIG. 3, the deployment guide assembly 10 is mounted inside the headliner 14 of a vehicle 12 as depicted from a partially cut-away, side cross-sectional view adjacent the inflatable curtain 16 previous to deployment. FIG. 3 is viewed from the vantage point of the front of the vehicle 12 looking rearward. The inflatable curtain 16 is mounted to a roof rail 70 through the mounting clip 22. The mounting clip 22 and inflatable curtain 16 are fastened to the roof rail 70 through a fastener 72. The inflatable curtain 16 is stowed in an envelope 74 between the headliner 14 and the roof rail 70. The headliner 14 is affixed adjacent the vehicle roof 76. The headliner 14 has a sloped portion 78 that extends from adjacent the vehicle roof 76 toward the B-pillar 42 on the side structure 28 of the vehicle 12. A terminal end 80 of the sloped portion 78 of the headliner 14 is located adjacent a side trim panel 82.

Mounted on the sloped portion 78 of the headliner 14 is the deployment guide assembly 10. As the section view of FIG. 3 cuts through a portion of the guide member 30, only one guide rail 32 is shown. The guide rail 32 may be affixed to the sloped portion 78 of the headliner 14 adjacent the inflatable curtain 16. The guide rails 32 may alternatively be mounted or otherwise suspended from the vehicle roof 76 so that the guide member 30 can be located adjacent the inflatable curtain 16.

As illustrated in FIG. 3, the guide member 30 is in the retracted position when the inflatable curtain 16 is in a stored state. The top edge 34 of the guide member 30 is adjacent the top edge 36 of the guide rails 32 when in the retracted position. The guide member 30 is located on an inboard side of the inflatable curtain 16 so that the inflatable curtain 16 deploys adjacent to and parallel with the side structure 28 of the vehicle 12. The guide member 30 also has a roughed surface on the side 50 adjacent the inflatable curtain 16 to facilitate the frictional pull of the guide member 30 from the retracted position to the guiding position when the inflatable curtain 16 is deployed.

The various components described and illustrated in conjunction with FIG. 3 may be altered, rearranged, omitted, or supplemented with additional parts or arranged in a variety of different configurations. For instance, the profile of the envelope 74 differs between different vehicles. Consequently, the placement, mounting angle, and airbag location may be different than depicted in FIG. 3.

Referring to FIG. 4, the deployment guide assembly 10 is shown in contact with the deploying inflatable curtain 16 as depicted from a partially cut-away, side cross-sectional view. FIG. 4 is viewed from the vantage point of the front of the vehicle 12 looking rearward. The guide member 30 is being moved from the retracted position to the guiding position by the deploying inflatable curtain 16. As illustrated, the deployment guide assembly 10 is still mounted behind the headliner 14, but the guide member 30 is extending below the headliner 14 and into a passenger compartment 90 of the vehicle 12.

The inflatable curtain 16 is partially inflated as it unfolds from its stored state. As the inflatable curtain 16 inflates, it bends the sloped portion 78 of the headliner 14 back so the terminal end 80 of the sloped portion 78 of the headliner 14 is no longer adjacent the side trim panel 82. The inflatable curtain 16 then begins to inflate downward into the passenger compartment 90 of the vehicle 12.

As the inflatable curtain 16 inflates downward, it contacts the guide member 30 in the retracted position. The side 50 of the guide member 30 adjacent the inflatable curtain 16 may have a roughed surface that is ribbed, has a heavy grain, or is otherwise textured to create friction between the deploying inflatable curtain 16 and the guide member 30. The frictional forces of the inflatable curtain 16 deploying downward and against the guide member 30 loose the guide member 30 from the catch 64. Once the guide member 30 is no longer held in the retracted position by the catch 64, the guide member 30 can be extended downward by a combination of the downward frictional forces of the deploying inflatable curtain 16 and gravity. The guide member 30 slides down toward a guiding position along slotted sections 52 of the guide rails 32.

FIG. 4 shows the guide member 30 as it moves from the retracted position to the guiding position. The guiding position of the guide member 30 may be several inches below the terminal end 80 of the headliner 14. The guiding position of the guide member 30 is also substantially parallel with the side structure 28 of the vehicle 12. The deploying inflatable curtain 16 then inflates between the guide member 30 and the side trim panel 82 on the B-pillar 42. The extended guide member 30 forces the inflatable curtain 16 to deploy in a direction substantially parallel to the side structure 28 of the vehicle 12. Consequently, the likelihood of occupant injury is decreased.

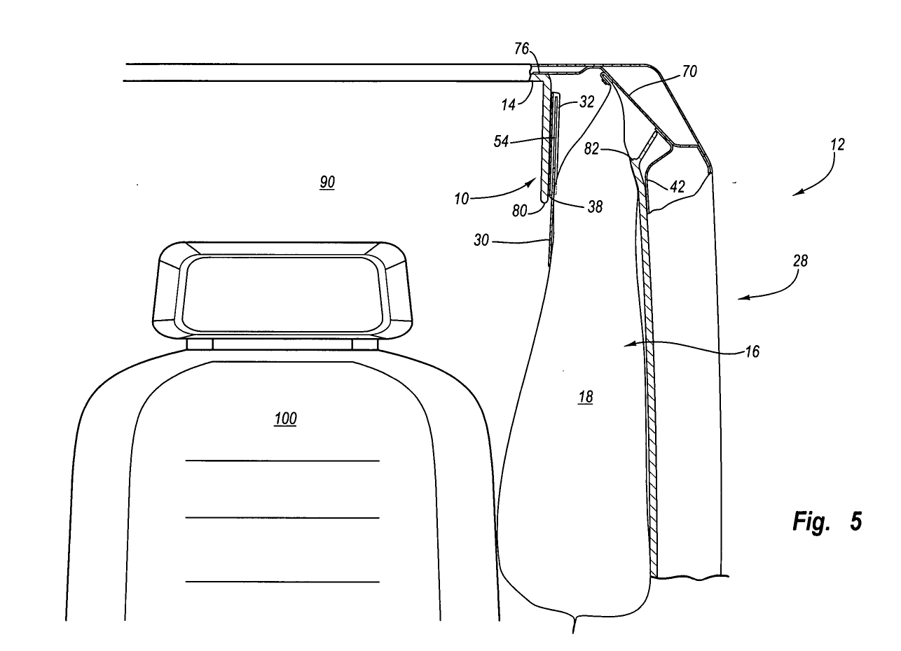

Referring to FIG. 5, the deployment guide assembly 10 is shown adjacent the fully-deployed inflatable curtain 16 as depicted from a partially cut-away, side cross-sectional view. FIG. 5 is viewed from a vantage point from the front of the vehicle 12 looking rearward. The guide member 30 is in the guiding position and extends several inches below the terminal end 80 of the headliner 14. The guide member 30 is engaged with guide rails 32 that direct the path of the extending guide member 30 through slotted sections 54 in the guide rails 32. Rail engagement arms 52 (as shown in FIG. 2) engage the slotted sections 54 and slide down the guide rails 32 from the retracted position to the guiding position. The guide member 30 is held in the guiding position through the rail engagement arms' engagement with the slotted sections 54 near the bottom edge 38 of the guide rails 32.

The guide member 30 in the guiding position is substantially parallel to the side structure 28 of the vehicle 12. The guide member 30 is thereby able to repeatably direct the deployment of the inflatable curtain 16 between the guide member 30 and the B-pillar 42 parallel to the side structure 28 of the vehicle 12. Without the guide member 30, the inflatable curtain 16 may contact the B-pillar 42 and alter the trajectory of the deploying inflatable curtain 16 toward a vehicle occupant. The fully inflated cushion 18 of the inflatable curtain 16 parallel to the side structure 28 provides impact protection and occupant retention for vehicle occupants sitting in a seat 100 in the passenger compartment 90 adjacent the deployed inflatable curtain 16.

The various components described and illustrated in conjunction with FIGS. 1-5 may be altered, rearranged, omitted, or supplemented with additional parts in a variety of ways. As mentioned previously, the deployment guide assembly 10 can be used in conjunction with other airbag systems, such as overhead airbag systems that deploy parallel to the windshield or rear window of a vehicle. Furthermore, additional deployment guide assemblies 10 may be used in a variety of locations within the vehicle 12.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. An airbag deployment guide assembly, comprising:
a guide member mountable adjacent an airbag, the guide member slidably movable from a retracted position to a guiding position for guiding deployment of the airbag.

2. The guide assembly of claim 1, wherein the guide member is positionable substantially parallel to a window of a vehicle in the guiding position.

3. The guide assembly of claim 1, further comprising at least one guide rail slidably retaining the guide member.

4. The guide assembly of claim 3, wherein the guide member has at least one rail engagement arm, such that the at least one guide rail slidably retains the at least one rail engagement arm.

5. The guide assembly of claim 1, wherein the deployment of the airbag moves the guide member from the retracted position to the guiding position.

6. The guide assembly of claim 5, wherein the guide member has a roughed surface to facilitate a frictional pull of the guide member from the retracted position to the guiding position by the deploying airbag.

7. The guide assembly of claim 1, wherein the guide member is mountable adjacent the airbag on an inboard side of the airbag when the guide assembly is installed within a vehicle.

8. The guide assembly of claim 1, wherein the guide member is mountable adjacent a B-pillar of a vehicle.

9. The guide assembly of claim 1, wherein the guide member is substantially planar.

10. The guide assembly of claim 1, wherein the guide member is mountable in the retracted position behind a headliner of a vehicle, such that the guide member extends below the headliner of the vehicle in the guiding position.

11. The guide assembly of claim 1, further comprising a catch that releasably retains the guide member in the retracted position.

12. An airbag deployment guide assembly, comprising:
a guide member mountable adjacent an airbag, the guide member extendable from a retracted position to a guiding position that is substantially parallel to a window of a vehicle for guiding deployment of the airbag.

13. The guide assembly of claim 12, further comprising at least one guide rail slidably retaining the guide member.

14. The guide assembly of claim 13, wherein the guide member has at least one rail engagement arm, such that the at least one guide rail slidably retains the at least one rail engagement arm.

15. The guide assembly of claim 14, wherein the guide member slidably extends from the retracted position to the guiding position as directed by the at least one guide rail.

16. The guide assembly of claim 15, wherein the deployment of the airbag extends the guide member from the retracted position to the guiding position.

17. The guide assembly of claim 16, wherein the guide member has a roughed surface to facilitate a frictional pull of the guide member from the retracted position to the guiding position by the deploying airbag.

18. The guide assembly of claim 16, wherein the guide member is mountable adjacent the airbag on an inboard side of the airbag when the guide assembly is installed within the vehicle.

19. The guide assembly of claim 18, wherein the guide member is mountable adjacent a B-pillar of the vehicle.

20. The guide assembly of claim 18, wherein the guide member is substantially planar.

21. The guide assembly of claim 20, wherein the at least one guide rail and the guide member is mountable behind a headliner of a vehicle when the guide member is in the retracted position, such that the guide member extends below the headliner in the guiding position.

22. The guide assembly of claim 21, further comprising a catch that releasably retains the guide member in the retracted position.

23. An airbag deployment guide assembly, comprising:
a guide member slidably movable from a retracted position to a guiding position for guiding a deployment of an airbag, the guide member being substantially planar; and
a guide rail slidably retaining the guide member, the guide rail mountable in a headliner of a vehicle adjacent the airbag.

24. The guide assembly of claim 23, wherein the guide member is positionable substantially parallel to a window of the vehicle in the guiding position.

25. The guide assembly of claim 23, wherein the deployment of the airbag moves the guide member from the retracted position to the guiding position.

26. The guide assembly of claim 25, wherein the guide member has a roughed surface to facilitate a frictional pull of the guide member from the retracted position to the guiding position by the deploying airbag.

27. The guide assembly of claim 23, wherein the guide rail is mountable in the headliner on an inboard side of the airbag when the guide assembly is installed within the vehicle.

28. The guide assembly of claim 23, wherein the guide rail is mountable in the headliner adjacent a B-pillar of the vehicle, such that the guide member is adjacent the B-pillar in the guiding position.

29. The guide assembly of claim 23, wherein the guide member has at least one rail engagement arm, such that the guide rail slidably retains the at least one rail engagement arm.

30. The guide assembly of claim 23, wherein the guide member extends below the headliner of the vehicle in the guiding position.

31. The guide assembly of claim 23, further comprising a catch that releasably retains the guide member in the retracted position.

32. An airbag deployment guide assembly, comprising:
an inflatable curtain deployable adjacent a side structure of a vehicle; and
a guide member movable from a retracted position to a guiding position, the guide member shaped to guide the inflatable curtain substantially parallel to a side window of the vehicle during deployment, the inflatable curtain having a surface for contacting and extending the guide member from the retracted position to the guiding position during deployment.

33. The guide assembly of claim 32, further comprising at least one guide rail slidably retaining the guide member.

34. The guide assembly of claim 33, wherein the guide member has at least one rail engagement arm, such that the at least one guide rail slidably retains the at least one rail engagement arm.

35. The guide assembly of claim 32, wherein the guide member is mountable adjacent the airbag on an inboard side of the airbag when the guide assembly is installed within the vehicle.

36. The guide assembly of claim 32, wherein the guide member is mountable adjacent a B-pillar of the vehicle.

37. The guide assembly of claim 32, wherein the guide member is substantially planar.

38. The guide assembly of claim 32, wherein the guide member is mountable in the retracted position behind a headliner of the vehicle, such that the guide member extends below the headliner in the guiding position.

39. The guide assembly of claim 32, further comprising a catch that releasably retains the guide member in the retracted position.

40. The guide assembly of claim 32, wherein the guide member has a roughed surface to facilitate a frictional pull of the guide member from the retracted position to the guiding position by the deploying airbag.

41. A method of guiding deployment of an inflatable curtain with a deployment guide assembly comprising a guide member mounted adjacent an inflatable curtain, the guide member slidably movable from a retracted position to a guiding position, the method comprising:
deploying the inflatable curtain such that the inflatable curtain contacts the guide member upon deployment;
moving the guide member from the retracted position to the guiding position with the deploying inflatable curtain; and
guiding the deployment of the inflatable curtain substantially parallel to a window of a vehicle with the guide member.

42. The method of claim 41, wherein moving the guide member from the retracted position to the guiding position comprises extending the guide member below a headliner of the vehicle in the guiding position.

43. The method of claim 41, wherein moving the guide member with the inflatable curtain comprises moving the guide member through the use of friction created between the guide member and the deploying inflatable curtain when the inflatable curtain contacts the guide member.

44. The method of claim 41, wherein the deployment guide assembly further comprises guide rails mounted on an inboard side of the inflatable curtain, wherein guiding the deployment of the inflatable curtain comprises guiding the inflatable curtain between an occupant and a side structure of the vehicle.
